(19) United States
(12) Patent Application Publication
(10) Pub. No.: US 2024/0107414 A1
(43) Pub. Date: Mar. 28, 2024

(54) UE ASSISTED HANDOVER TO SECONDARY CELL VIA BEAM FAILURE RECOVERY

(71) Applicant: QUALCOMM Incorporated, San Diego, CA (US)

(72) Inventors: Yu-Chieh HUANG, Taipei City (TW); Kuhn-Chang LIN, Chiayi City (TW); Jen-Chun CHANG, New Taipei City (TW); Wen-Hsin HSIA, New Taipei City (TW); Chia-Jou LU, Taipei City (TW); Sheng-Chih WANG, New Taipei City (TW); Chenghsin LIN, New Taipei (TW); Yeong Leong CHOO, New Taipei City (TW); Chun-Hsiang CHIU, New Taipei City (TW); Chihhung HSIEH, Taipei City (TW); Kai-Chun CHENG, Taipei City (TW); Chung Wei LIN, Taipei City (TW)

(21) Appl. No.: 17/934,838

(22) Filed: Sep. 23, 2022

(51) Int. Cl. H04W 36/30; H04W 36/00

(52) U.S. Cl. CPC H04W 36/305; H04W 36/0069

(57) ABSTRACT

This disclosure provides systems, methods and apparatus, including computer programs encoded on computer storage media, for switching a secondary cell to a primary cell. A user equipment (UE) monitors a first radio condition of the UE for beams of a primary cell and a second radio condition for beams of one or more secondary cells configured for the UE in carrier aggregation. The UE transmits a request to configure a candidate beam of at least one candidate secondary cell as a new primary cell in response to the first radio condition not satisfying a first threshold and the second radio condition for the at least one candidate secondary cell satisfying a second threshold. A base station determines to reconfigure at least one secondary cell as the new primary cell. The base station and the UE perform a handover of the UE to the new primary cell.

### TECHNICAL FIELD

The present disclosure relates to wireless communications including a user equipment (UE) assisted handover to a secondary cell (SCell) via a beam failure recovery (BFR) mechanism.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

In some aspects, the techniques described herein relate to a method of wireless communication for a user equipment (UE), including monitoring a first radio condition of the UE for beams of a primary cell and a second radio condition for beams of one or more secondary cells configured for the UE in carrier aggregation. The method includes transmitting a request to configure a candidate beam of at least one candidate secondary cell of the one or more secondary cells as a new primary cell in response to the first radio condition not satisfying a first threshold and the second radio condition for the at least one candidate secondary cell satisfying a second threshold. The method includes performing a handover to the new primary cell.

The present disclosure also provides an apparatus (e.g., a UE) including a memory storing computer-executable instructions and at least one processor configured to execute the computer-executable instructions to perform the above method, an apparatus including means for performing the above method, and a non-transitory computer-readable medium storing computer-executable instructions for performing the above method.

One innovative aspect of the subject matter described in this disclosure can be implemented in a method of wireless communication for a base station (BS) including configuring a user equipment (UE) with a primary cell and one or more secondary cells in carrier aggregation. The method includes receiving a request to configure a candidate beam of at least one candidate secondary cell of the one or more secondary cells as a new primary cell, wherein the request indicates that a first radio condition of the UE for beams of a primary cell does not satisfy a first threshold and that a second radio condition for the candidate beam of the at least one candidate secondary cell satisfies a second threshold. The method includes handing over the UE to the new primary cell.

The present disclosure also provides an apparatus (e.g., a BS) including a memory storing computer-executable instructions and at least one processor configured to execute the computer-executable instructions to perform the above method, an apparatus including means for performing the above method, and a non-transitory computer-readable medium storing computer-executable instructions for performing the above method.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communications system and an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 shows a diagram illustrating an example disaggregated base station architecture.

FIG. 5 is a diagram illustrating an example of a beam failure detection procedure.

FIG. 6 is a diagram illustrating an example procedure for fast recovery in a dual connectivity scenario.

FIG. 7 is a diagram illustrating an example procedure for switching a secondary cell (SCell) to a new primary cell (PCell).

FIG. 8 is a logical flow diagram of an example process for switching to a SCell in response to beam failure of a PCell.

FIG. 9 is a logical flow diagram of an example process for a SCell switch procedure.

FIG. 10 is a diagram of an example media access control (MAC) control element (CE) for indicating suitable SCell candidates for an SCell switch.

FIG. 11 is a message diagram illustrating example messages between a base station and a UE.

FIG. 12 is a conceptual data flow diagram illustrating the data flow between different means/components in an example base station.

FIG. 13 is a conceptual data flow diagram illustrating the data flow between different means/components in an example UE.

FIG. 14 is a flowchart of an example method for a UE to perform beam failure detection procedures using beam failure prediction.

FIG. 15 is a flowchart of an example method for a base station to control beam failure prediction at a UE.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth© standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In wireless communications, beamforming may be used to compensate for power loss in communication between a transmitter and receiver. For example, in millimeter wave (mmW or mmWave) communications, the frequency may be relatively high compared to conventional communication channels and signal attenuation may be relatively large. However, due to the uncertain nature of a wireless environment and unexpected blocking, beam may be vulnerable to beam failure. 5G systems may implement a beam failure detection (BFD) procedure to assist in maintaining a strong channel connection between a user equipment (UE) and a base station. In a BFD procedure, the UE may be configured with rules for determining whether a beam failure has occurred based on physical layer measurements of a beam failure detection reference signal (BFD-RS). For example, the UE may count a number of beam failure instances during a measurement window. If the number of beam failure instances satisfies a threshold during the measurement window, the UE may declare a beam failure.

In the event of a beam failure, a beam failure recovery (BFR) procedure may be used in some cases. For example, the UE may measure candidate beams of the primary cell (PCell) to determine whether one of the candidate beams would be suitable for maintaining the link with the PCell. If the UE reports a suitable beam, the network may update the beam of the PCell.

An alternative to the BFR procedure is a handover to a neighbor cell. The UE may be configured with measurement objects for neighbor cells. The UE may measure the quality of the neighbor cells and provide a report to the network. In some cases, the report may be triggered by a condition based on the quality of the neighbor cells and/or the PCell. For example, if the quality of the PCell decreases or a quality of the neighbor cell becomes better than the PCell, the UE may report the relevant qualities, and the network may initiate a handover of the UE to a neighbor cell.

In another alternative, for a dual connectivity case where the UE is connected to a master cell group (MCG) including a PCell and a second cell group (SCG) including a primary SCG cell (PSCell), the UE may use a fast recovery procedure to forward MCG failure information to a base station via SCG RRC signaling. The MCG may deliver a radio resource control (RRC) reconfiguration message to the UE utilizing the SCG RRC signaling. The SCG RRC signaling may be used to handover the UE to the SCG.

For a UE operating with carrier aggregation (CA) but without an SCG, the UE may be connected to one or more secondary cells. The above techniques, however, may not allow a UE to be handed over to one of the secondary cells in the event of a beam failure for the PCell. For instance, although a BFD procedure may also apply to secondary cells, such procedures may result in a change of beam for a secondary cell, but the secondary cell does not become a primary cell. Similarly, a secondary cell may not be considered a neighbor cell and may not be configured with a corresponding measurement object. Therefore, in the event of a beam failure of the PCell, the UE may not provide measurements of the SCell, and an SCell will not be selected for handover. Finally, the MCG fast recovery procedure is not applicable without an SCG. In view of the foregoing, a UE operating without an SCG may experience a radio link failure (RLF) when a beam failure occurs on the primary cell. An RLF recovery procedure includes suspending ongoing communication until the UE re-synchronizes with the network

In an aspect, the present disclosure provides techniques for a UE to assist with a handover from a PCell to an SCell in the event of a beam failure on the PCell. For example, when there is no suitable alternative beam for the PCell and there is no suitable neighbor cell, the UE may request a handover to a suitable SCell that can be reconfigured as a new PCell. For instance, the UE may transmit a request for an SCell switch as a media access control (MAC) control element (CE) or a RRC message. The request may identify one or more candidate SCell beams that are suitable for a PCell. The base station may determine to reconfigure one of the candidate SCells as a new PCell. The base station may initiate a handover of the UE to the PCell using an RRC reconfiguration message. Accordingly, a UE may be handed over to an SCell in the event of a beam failure.

Particular implementations of the subject matter described in this disclosure can be implemented to realize one or more of the following potential advantages. The UE assisted handover to a secondary cell may prevent a RLF and allow the UE to continue the ongoing communication. In some implementations, signaling the request via a MAC-CE may be faster than RRC procedures.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

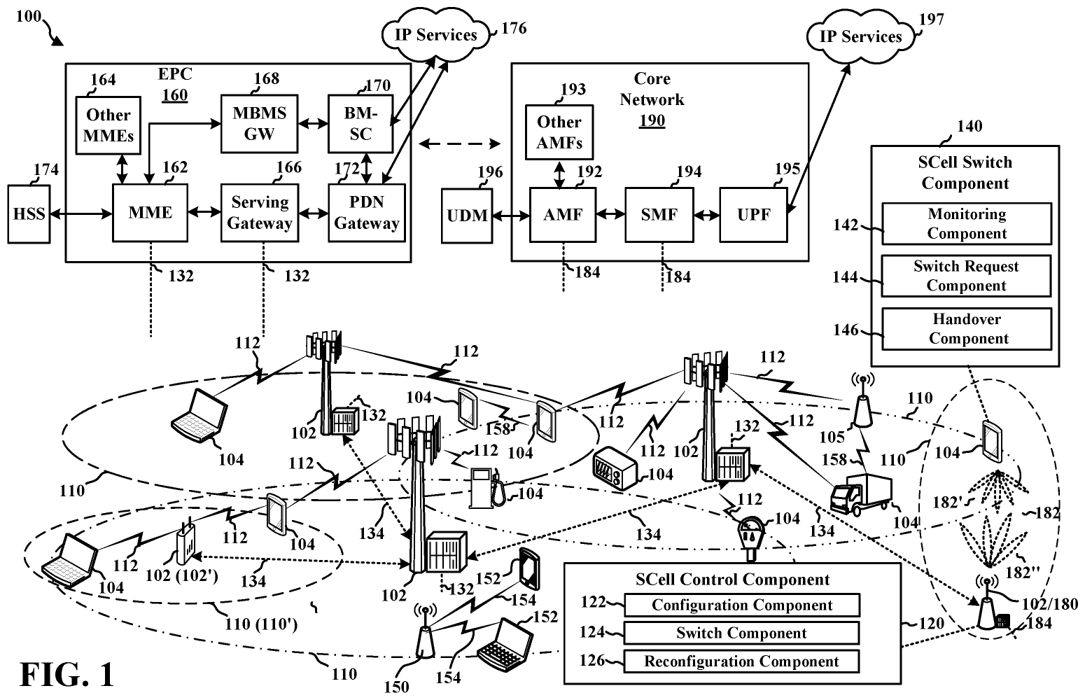

FIG. 1 is a diagram illustrating an example of a wireless communications system and an access network 100. The wireless communications system (also referred to as a wireless wide area network (WWAN)) includes base stations 102, UEs 104, relay devices 105, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some implementations, one or more of the receiving devices such as UEs 104 may include a SCell switch component 140 configured to perform a SCell switch procedure. The SCell switch component 140 may include a monitoring component 142 configured to monitor a first radio condition of the UE for beams of a primary cell and a second radio condition for beams of one or more secondary cells configured for the UE in carrier aggregation. The SCell switch component 140 may include a switch request component 144 configured transmit a request to configure a candidate beam of at least one candidate secondary cell of the one or more secondary cells as a new primary cell in response to the first radio condition not satisfying a first threshold and the second radio condition for the at least one candidate secondary cell satisfying a second threshold. The SCell switch component 140 may include a handover component 146 configured to perform a handover to the new primary cell.

In some implementations, one or more of the base stations 102 may include a SCell control component 120 configured to control SCell switching for a UE. The SCell control component 120 may include a configuration component 122 configured to configure the UE with a primary cell and one or more secondary cells in carrier aggregation. The SCell control component 120 may include a switch component 124 configured to receive a request to configure a candidate beam of at least one candidate secondary cell of the one or more secondary cells as a new primary cell. For example, the request may indicate that a first radio condition of the UE for beams of a primary cell does not satisfy a first threshold and that a second radio condition for the candidate beam of the at least one candidate secondary cell satisfies a second threshold. The SCell control component 120 may include a reconfiguration component 126 configured to hand over the UE to the new primary cell.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 134 (such as X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

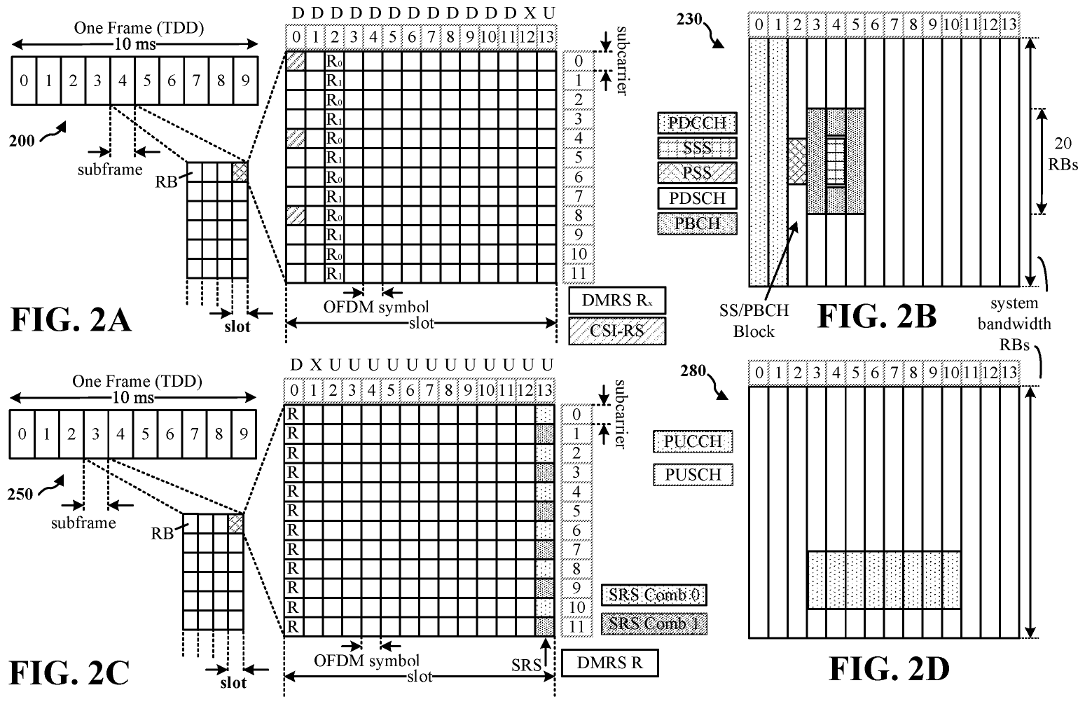

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5GNR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2 slots/subframe. The subcarrier spacing and symbol length/duration are a function of the numerology. The subcarrier spacing may be equal to 2^{μ}*15 kHz, where y is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (s).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used.

The UE may transmit sounding reference signals (SRS). An SRS resource set configuration may define resources for SRS transmission. For example, as illustrated, an SRS configuration may specify that SRS may be transmitted in the last symbol of a subframe. The SRS may have a comb structure, and a UE may transmit SRS on one comb for each SRS port. The SRS may be used by a base station for channel quality estimation to enable frequency-dependent scheduling on the UL. The SRS may also be used for channel estimation to select a precoder for downlink MIMO.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

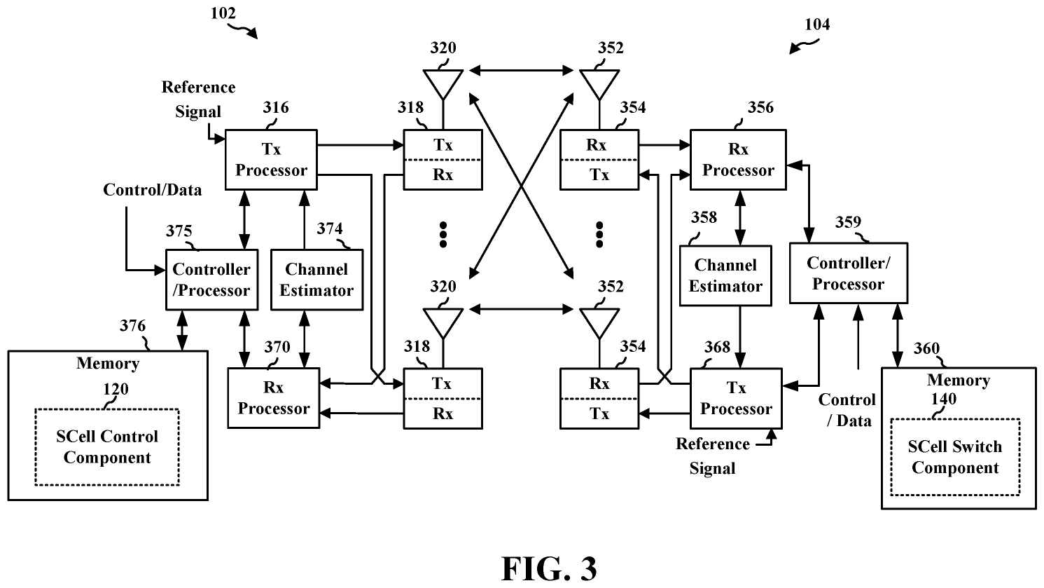

FIG. 3 is a diagram of an example of abase station 102 and a UE 104 in an access network. The UE 104 may be an example of a receiving device. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 104. Each spatial stream may be provided to a different antenna 320 via a separate transmitter 318Tx. Each transmitter 318Tx may modulate an RF carrier with a respective spatial stream for transmission.

At the UE 104, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 104. If multiple spatial streams are destined for the UE 104, they may be combined by the Rx processor 356 into a single OFDM symbol stream. The Rx processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 102. These soft decisions may be based on channel estimates computed by the channel estimator 358. The soft decisions are decoded and deinterleaved to recover the data and control signals that were originally transmitted by the base station 102 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 102, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 102 in a manner similar to that described in connection with the receiver function at the UE 104. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK or NACK protocol to support HARQ operations.

At least one of the Tx processor 368, the Rx processor 356, and the controller/processor 359 may be configured to perform aspects in connection with the SCell switch component 140 of FIG. 1. For example, the memory 360 may include executable instructions defining the SCell switch component 140. The Tx processor 368, the Rx processor 356, and/or the controller/processor 359 may be configured to execute the SCell switch component 140.

At least one of the Tx processor 316, the Rx processor 370, and the controller/processor 375 may be configured to perform aspects in connection with the prediction control component 120 of FIG. 1. For example, the memory 376 may include executable instructions defining the prediction control component 120. The Tx processor 316, the Rx processor 370, and/or the controller/processor 375 may be configured to execute the prediction control component 120.

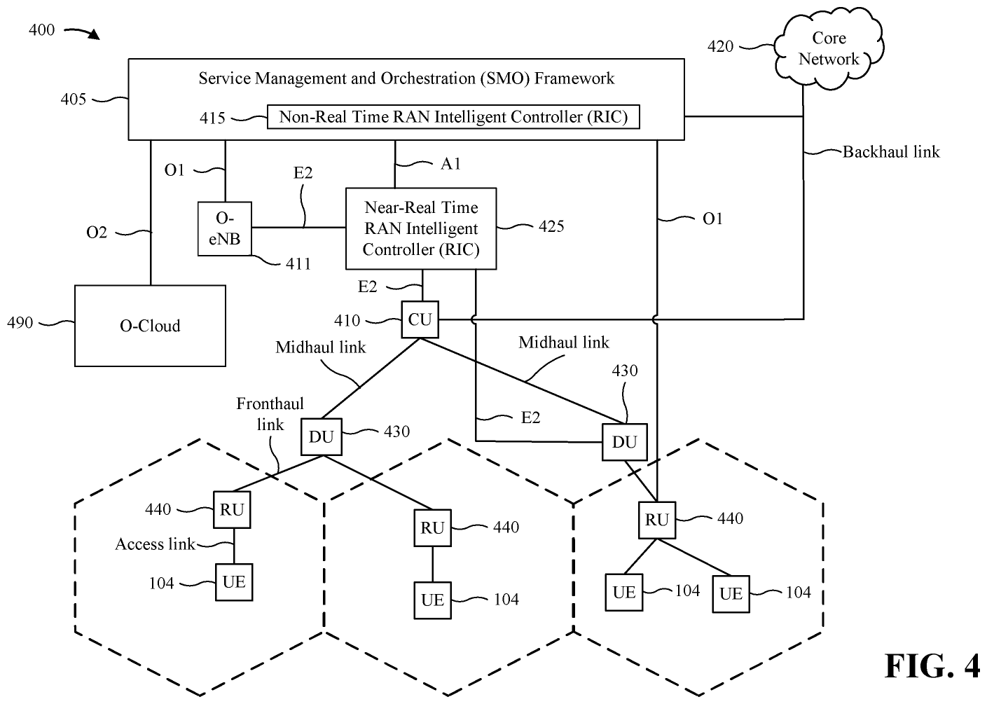

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit—User Plane (CU-UP)), control plane functionality (i.e., Central Unit—Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

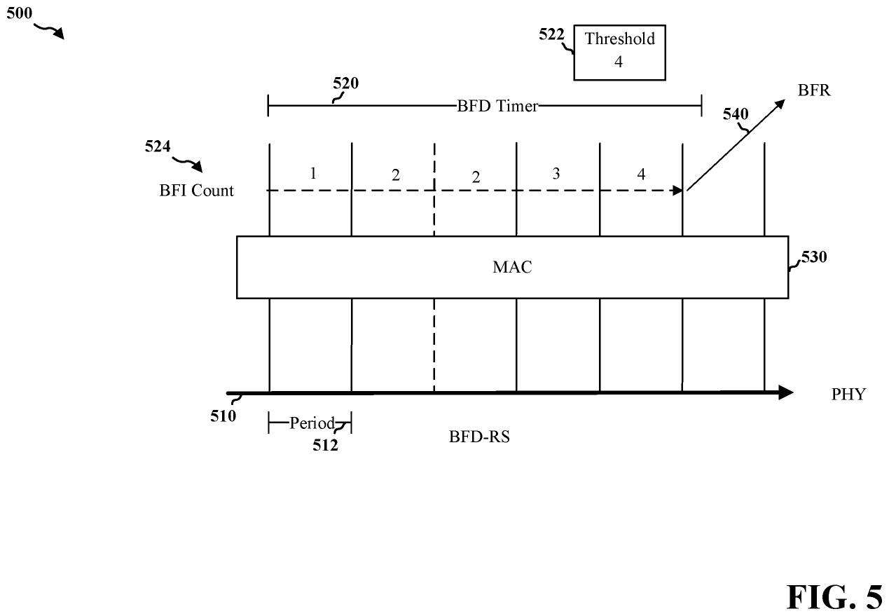

FIG. 5 is a diagram 500 illustrating an example of a beam failure detection procedure. A UE 104 may be configured with a periodic BFD-RS 510. For example, the BFD-RS 510 may be a synchronization signal block (SSB) or a channel state information reference signal (CSI-RS) that is transmitted on an active beam for the UE. The BFD-RS 510 may have a periodicity that defines a period 512. The UE 104 may measure the BFD-RS at the PHY layer. For example, the UE 104 may measure a signal to interference plus noise ratio (SINR) or reference signal received power (RSRP) of the BFD-RS 510. The UE 104 may detect a beam failure instance at the PHY layer when the PHY measurement does not satisfy a threshold (e.g., a BFD threshold, which may be referred to as Qₒᵤₜ_LR or rsrp-ThresholdSSB). The PHY layer may report a beam failure instance (BFI) to a MAC layer 530.

The MAC layer 530 may be configured with a BFD timer 520 and a BFI threshold 522. The BFD timer 520 may define a time period for counting BFIs from the PHY layer. The BFI threshold 522 may define a number of BFIs when a beam failure is declared. The MAC layer 530 may maintain a BFI count 524 of BFIs received from the PHY layer during the BFD timer 520. If the MAC layer 530 receives a BFI from the PHY layer, the MAC layer 530 may increment the BFI count 524. The MAC layer 530 may measure the BFD timer 520 starting when the MAC layer 530 increments the BFI count from 0 to 1. If a BFD-RS is received where the PHY layer measurement satisfies the threshold, the PHY layer may not report a BFI and the BFI count 524 may remain unchanged. If the BFI count 524 satisfies the BFI threshold 522 during the BFD timer 520, the UE 104 may initiate a beam failure recovery (BFR) procedure 540. For example, as illustrated, the BFI threshold 522 may be set to 4, and the UE 104 may initiate the BFR procedure 540 when the BFI count 524 reaches a value of 4.

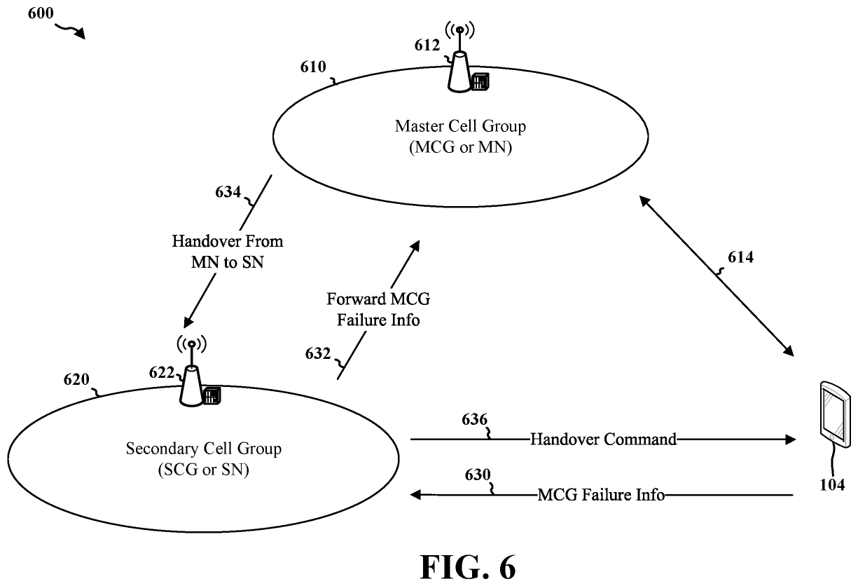

FIG. 6 is a diagram 600 illustrating a procedure for fast recovery in a dual connectivity scenario. The UE 104 may be in communication with a master cell group (MCG) 610, which may be referred to as a master network (MN), and a secondary cell group (SCG) 620, which may be referred to as a secondary network (SN). The MCG 610 includes a PCell 612 and the SCG 620 includes a PSCell 622. A link 614 between the PCell 612 and the UE 104 may experience a failure such as radio link failure. Instead of declaring a RLF and suspending communications, the UE 104 may transmit MCG failure information 630 to the PSCell 622 via SCG RRC signaling. The PSCell 622 may forward the MCG failure information 630 as information 632 via a backhaul connection. The MCG may then handover the UE 104 to the PSCell 622 by sending handover information 634 to the PSCell 622 via the backhaul connection. The SCG may forward the handover information 634 as a handover command 636 via the SCG RRC signaling. Accordingly, when the link 614 fails, the UE 104 may continue communications via the PSCell 622.

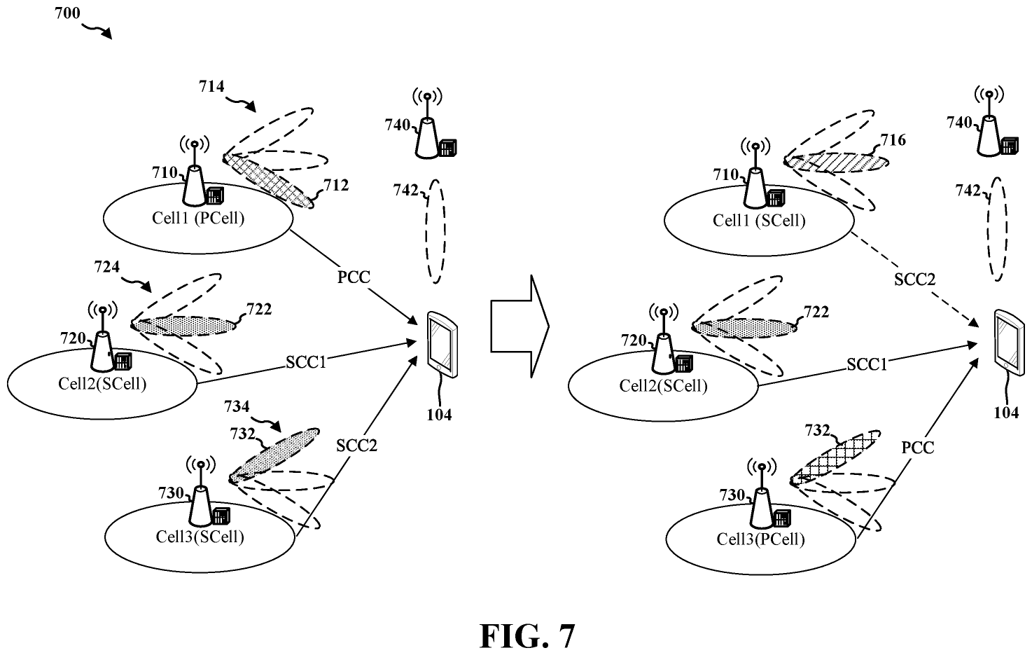

FIG. 7 is a diagram 700 illustrating a procedure for switching a secondary cell to a new primary cell. In the illustrated example, a UE 104 is configured with a first cell 710 as the PCell for a primary component carrier (PCC), a second cell 720 as an SCell for a secondary component carrier (SCC1), and a third cell 730 as an SCell for SCC2. Each configured cell may communicate with the UE 104 via a selected beam 712, 722, 732 of a plurality of beams 714, 724, 734. The UE 104 may also be configured with zero or more neighbor cells 740 to monitor. For example, the UE 104 may be configured with a measurement object corresponding to a reference signal 742 of each neighbor cell 740.

In an example beam failure scenario, the selected beam 712 of the PCell (e.g., first cell 710) may degrade in quality such that the selected beam 712 does not satisfy a threshold. The UE 104 may generate BFI at the PHY layer and the MAC layer may determine to initiate a BFR procedure 540. In an aspect, when the other beams of the plurality of beams 714 for the PCell (e.g., first cell 710) are not suitable and there is no suitable neighbor cell 740, the UE 104 may be handed over to an SCell (e.g., third cell 730) instead of declaring an RLF. For example, the third cell 730 may be configured for the UE 104 as a new PCell. The second cell 720 may remain a SCell. In some implementations, if a beam of the first cell 710 is suitable as a SCell, the first cell 710 may be configured for the UE 104 as a new SCell. For example, a beam 716 may be used for a secondary component carrier from the first cell 710.

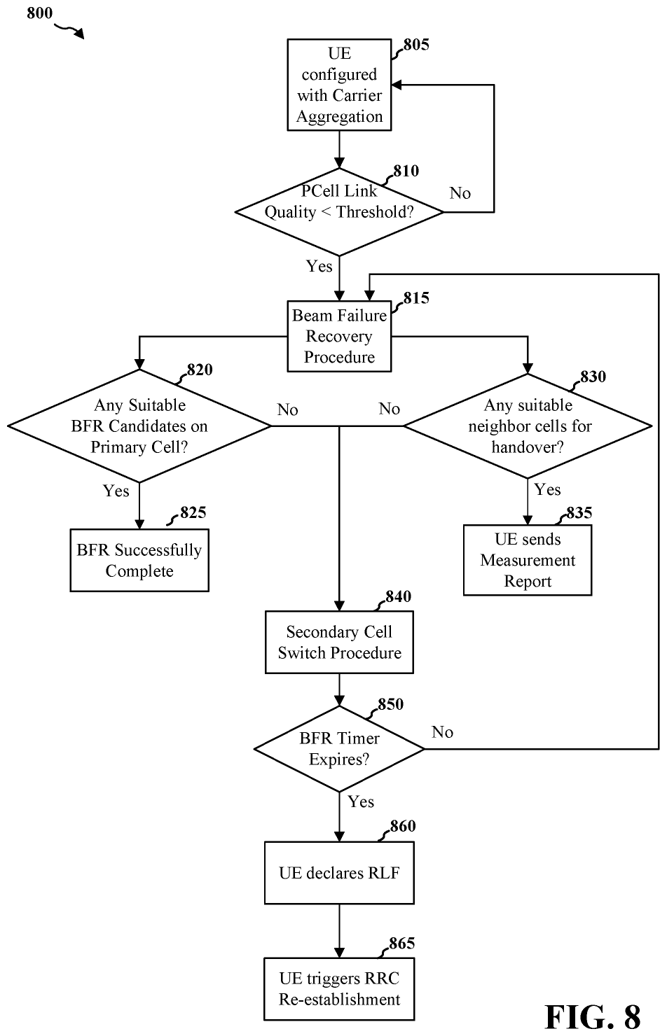

FIG. 8 is a logical flow diagram of an example process 800 for switching to a SCell in response to beam failure of a PCell. The process 800 may be performed by a UE (e.g., UE 104) in communication with one or more base stations providing cells (e.g., cells 710, 720, 730). Initially, at block 805, the UE 104 may be configured with carrier aggregation, for example, as illustrated in FIG. 7.

At block 810, the UE may periodically monitor the quality of the beam, for example, using the beam failure detection procedure illustrated in FIG. 5. While the PCell link quality remains above the BFD threshold, the UE 104 may communicate according to the carrier aggregation configuration. If the PCell link quality is less than the BFD threshold, the UE 104 may detect a beam failure.

At block 815, the UE 104 may start abeam failure recovery procedure, which may include measuring additional beams of the PCell (e.g., first cell 710). In an aspect, the beam failure recovery procedure may include concurrently measuring beams 724, 734 of secondary cells (e.g., second cell 720 and third cell 730). For instance, the UE 104 may measure a SINR or RSRP for each beam based on a BFD-RS. In some implementations, the UE 104 may also measure neighbor cells. For instance, neighbor cell measurements may include layer 3 measurements of RSRP. The beam recovery failure procedure may be performed during a beam failure recovery (BFR) timer, which may be referred to as beamFailureRecoveryTimer, and may be started in response to the beam failure detection in block 810.

At block 820, the UE 104 may determine whether any of the beams 714 for the primary cell (e.g., first cell 710) are suitable for beam failure recovery. For instance, the UE 104 may determine whether any of the beams 714 have a SINR greater than a first threshold, which may be referred to as a BFR threshold, Qᵢₙ_LR, or rsrp-ThresholdBFR. If so, at block 825, the UE 104 may report the suitable candidate beam and the beam failure recovery procedure may proceed to change the selected beam 712 for the PCell (e.g., first cell 710).

At block 830, the UE 104 may determine whether any of the neighbor cells 740 are suitable for a handover. For instance, the UE 104 may be configured with measurement objects for the neighbor cells 740 and for sending measurement reports to the PCell. If the measurements of one or more neighbor cells satisfy the criteria, the UE 104 may transmit the measurement report in block 835, which may cause the PCell to handover the UE 104 to the neighbor cell 740. In an aspect, block 820 and block 830 may be performed concurrently during a beam failure recovery timer, which may be referred to as beamFailureRecoveryTimer.

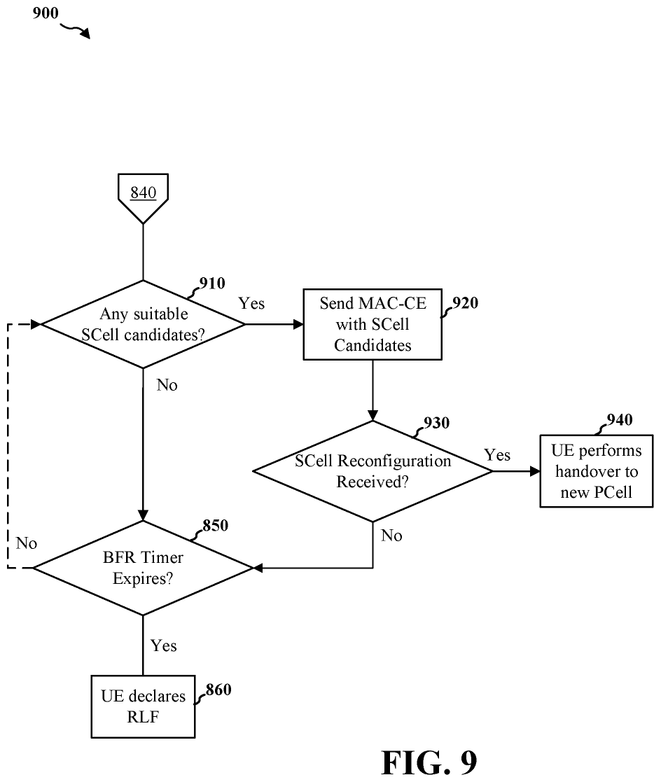

At block 840, the UE 104 may perform a secondary cell switch procedure according to aspects of the present disclosure. The secondary cell switch procedure may include monitoring radio conditions for beams of one or more secondary cells configured for the UE in carrier aggregation to determine whether any of the secondary cells is suitable to be a primary cell for the UE. The monitoring may occur concurrently with monitoring beams of the primary cell during the beam failure recovery procedure. Further details of the secondary cell switch procedure are discussed below with respect to FIGS. 9-11.

At block 850, the UE 104 may determine whether the beam failure recovery timer has expired. If the beam failure recovery timer has not expired, the beam failure recovery procedure including the secondary cell switch procedure may continue starting from block 815. If the beam failure recovery timer has expired, the UE 104 may proceed to block 860.

In block 860, the UE 104 may declare a radio link failure. A radio link failure may include suspending communications on the radio link until the radio link can be reestablished. For example, at block 865, the UE may trigger an RRC re-establishment using a RACH procedure.

FIG. 9 is a logical flow diagram of an example process 900 for a secondary cell switch procedure. The process 900 may be performed by a UE (e.g., UE 104) in communication with one or more base stations providing cells (e.g., cells 710, 720, 730). The process 900 may begin at block 840 of process 800 as discussed above with respect to FIG. 8. For example, the process 900 may occur during a beam failure recovery procedure when there are no suitable beam failure recovery candidate beams on the primary cell (e.g., block 820) and/or no suitable neighbor cells for handover (e.g., block 830).

At block 910, the UE 104 may determine whether there are any suitable SCell candidates. In some implementations, a suitable SCell candidate may be a beam from an SCell that has satisfied a threshold. For example, the UE 104 may be configured with a primary-secondary switching threshold. A measured radio condition (e.g., RSRP) of each beam of the secondary cells may be compared to the primary-secondary switching threshold to determine whether the beam is a suitable SCell candidate. In some implementations, the beams of the secondary cells may be compared to the best beam of the primary cell. For example, the UE 104 may be configured a primary-secondary switching offset. If the measured radio condition of the secondary cell beam is better than the measured radio condition of the best primary cell beam by at least the primary-secondary switching offset, the secondary cell beam may be considered a suitable SCell candidate. If the UE 104 determines a suitable SCell candidate, the process 900 may proceed to block 920. If there are no suitable SCell candidates, the process 900 may proceed to block 850.

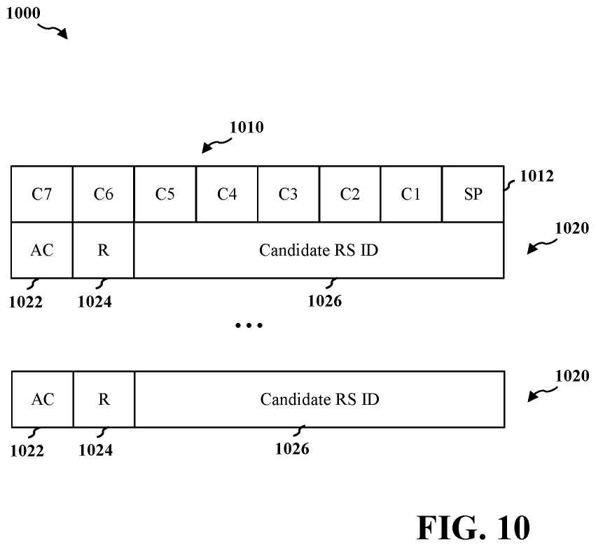

At block 920, the UE 104 may send a MAC-CE with one or more suitable SCell candidates. As discussed below regarding FIG. 10, the MAC-CE may be a BFR MAC-CE or a similar MAC-CE dedicated to SCell switch requests. The MAC-CE may indicate a candidate SCell index to be reconfigured as a PCell. The MAC-CE may also indicate a reference signal ID for the SCell to identify the candidate beam.

At block 930, the UE 104 may receive a reconfiguration of an SCell as a new PCell. For example, the UE 104 may receive an RRC reconfiguration message. If the UE 104 receives the reconfiguration, in block 940, the UE 104 may perform a handover to the new PCell. If the UE 104 does not receive an SCell reconfiguration, the process 900 may proceed to block 850 of the process 800 to determine whether the beam failure recovery timer has expired. In some implementations, if the beam failure recovery timer has not expired, the process 900 may return to block 910 to determine whether any other SCell candidates are suitable. If the beam failure recovery timer has expired, the process 900 may proceed to block 860, where the UE 104 declares an RLF.

FIG. 10 is a diagram of an example MAC-CE 1000 for indicating suitable SCell candidates for an SCell switch. The MAC-CE 1000 may be structured as a series of octets and may be transmitted on the PUSCH.

A cell index field 1010 (Ci) is included in first octet of the MAC-CE 1000 and may indicate whether a beam of an SCell with index Ci is included in the MAC-CE 1000. In some implementations, the Ci field may be extended to four octets to include up to 24 cell indices. An SP bit 1012 indicating beam failure detection may follow the cell index field 1010 in the first octet or the fourth octet.

Additional octets 1020 of the MAC-CE 1000 may identify individual beams using a reference signal ID 1026. For example, the reference signal ID 1026 may be set to the index of an SSB corresponding to the suitable beam for the SCell. Each additional octet 1020 may also include an AC bit 1022 indicating presence of a candidate reference signal ID in the octet. In some implementations, a reserved (R) bit, which is not used for a conventional beam failure report MAC-CE, may be used to indicate an SCell switch candidate. For example, the R bit 1024 may be used to indicate that the candidate RS is a SCell switch candidate rather than a beam change candidate for the SCell.

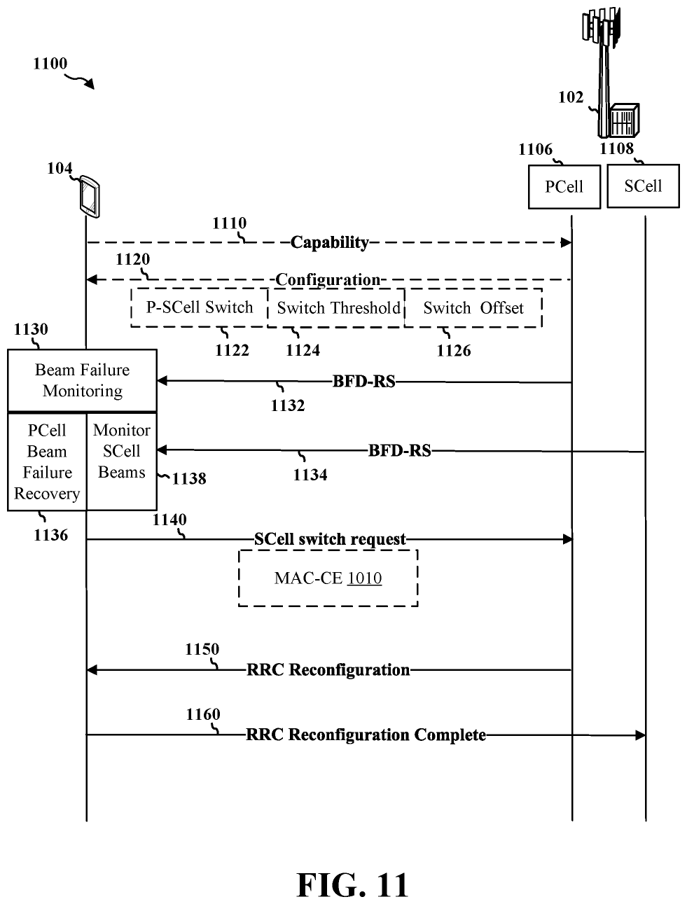

FIG. 11 is a message diagram 1100 illustrating example messages between a base station 102 and a UE 104. The UE 104 may be an example of a UE 104 including the SCell switch component 140. The base station 102 may include the SCell control component 120. In some implementations, the base station 102 may provide both a PCell 1106 and one or more SCells 1108. In other implementations, the PCell 1106 and the SCells 1108 may be provided by different base stations.

In some implementations, the UE 104 may optionally transmit a capability message 1110 to the base station 102. For example, the capability message 1110 may be a RRC message. The capability message 1110 may indicate, for example, that the UE 104 is capable of switching a SCell to a PCell. For instance, the capability may be referred to as a P-SCellSwitch capability.

In some implementations, the base station 102 may optionally transmit a configuration 1120. The configuration 1120 may be a RRC message. For example, the configuration 1120 may include a configuration of a SCell switch procedure. For instance, the configuration 1120 may include a flag (e.g., P-SCell Switch indication 1122) indicating whether an SCell switch procedure is active or allowed. The configuration 1120 may include a switch threshold 1124 (e.g., rsrp-ThresholdP-SCellSwitch) that defines a threshold for a radio condition (e.g., RSRP) of a suitable candidate SCell beam. The configuration 1120 may include a switch offset 1126 (e.g., rsrp-ThresholdOffsetP-SCellSwitch) that defines a threshold difference between a radio condition of a best beam of the PCell and the suitable candidate SCell beam.

The UE 104 may perform beam failure monitoring 1130. For example, the UE 104 may receive a beam failure detection reference signal (BFD-RS) 1132 from the PCell 1106. For example, the BFD-RS 1132 may be a SSB or CSI-RS. The UE 104 may detect a beam failure (e.g., FIG. 5) during beam failure monitoring 1130. The UE 104 may start the PCell beam failure recovery procedure 1136 for the PCell. In an aspect, concurrently with the PCell beam failure recovery procedure 1136, the UE 104 may monitor SCell beams in block 1138. For instance, the UE 104 may receive a BFD-RS 1134 from the SCell 1108 and measure a radio condition (e.g., RSRP or SINR).

If the UE 104 determines during the beam failure recovery procedure that an SCell beam is a suitable candidate beam, the UE 104 may transmit an SCell switch request 1140. For example, the SCell switch request 1140 may be the MAC-CE 1010. The SCell switch request 1140 may be transmitted on any available uplink resource. For example, the UE 104 may transmit an SCell switch request 1140 on an uplink grant for the PCell 1106 or one of the one or more SCells 1108. In some implementations, transmitting the SCell switch request 1140 on an SCell 1108 may be more reliable in the event of a beam failure on the PCell 1106.

The SCell switch request 1140 may identify suitable SCell candidates, but the network may control whether the UE 104 switches to the SCell 1108. For example, if the identified SCell 1108 is suitable to be a new PCell, the network may control a handover of the UE 104 to the SCell 1108 as a new PCell. For instance, the PCell 1106 may transmit an RRC reconfiguration message 1150 that reconfigures the SCell 1108 as a new PCell. For instance, the RRC reconfiguration message 1150 may configure new bandwidth parts or search spaces for SCell 1108. The RRC reconfiguration message 1150 may also specify that the SCell 1108 is the new PCell. In some implementations, the RRC reconfiguration message 1150 may reconfigure the PCell 1106 as a new SCell. The UE 104 may transmit an RRC Reconfiguration Complete message 1160 to complete a handover to the new PCell (formerly SCell 1108).

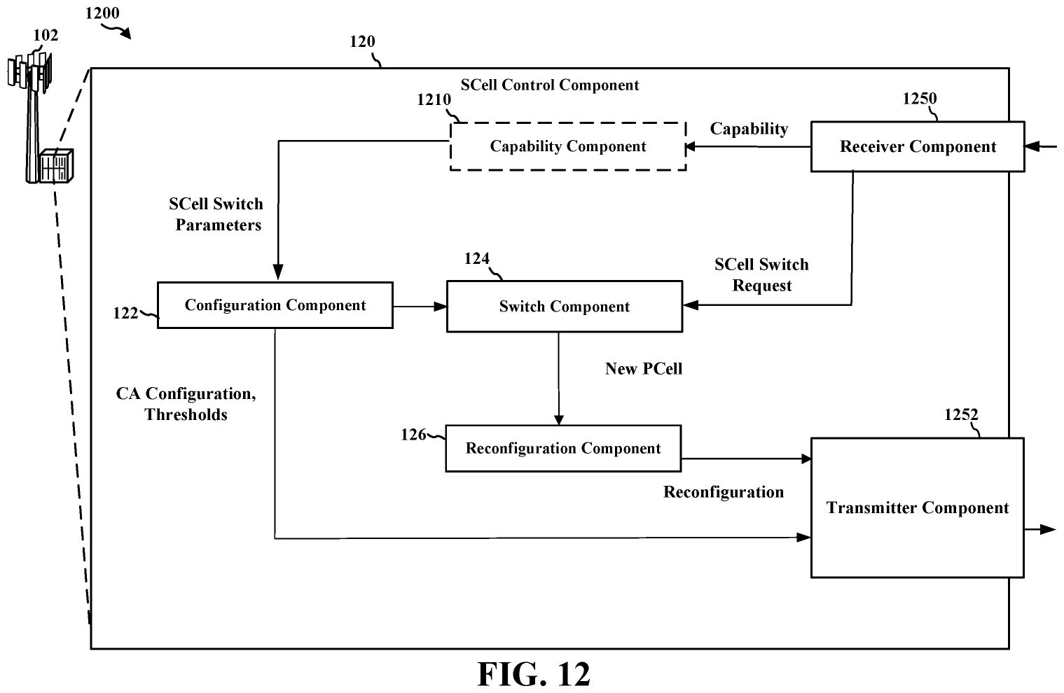

FIG. 12 is a conceptual data flow diagram 1200 illustrating the data flow between different means/components in an example base station 102, which may be an example of the base station 102 including the SCell control component 120. The SCell control component 120 may be implemented by the memory 376 and the Tx processor 316, the Rx processor 370, and/or the controller/processor 375 of FIG. 3. For example, the memory 376 may store executable instructions defining the prediction control component 120 and the Tx processor 316, the Rx processor 370, and/or the controller/processor 375 may execute the instructions.

The base station 102 may include a receiver component 1250, which may include, for example, a radio frequency (RF) receiver for receiving the signals described herein. The base station 102 may include a transmitter component 1252, which may include, for example, an RF transmitter for transmitting the signals described herein. In an aspect, the receiver component 1250 and the transmitter component 1252 may co-located in a transceiver such as illustrated by the Tx/Rx 318 in FIG. 3.

As discussed with respect to FIG. 1, the SCell control component 120 may include the configuration component 122, the switch component 124, and the reconfiguration component 126. In some implementations, the SCell control component 120 may optionally include a capability component 1210.

The receiver component 1250 may receive UL signals from the UE 104 including the capability message 1110, the SCell switch request 1140, or the RRC reconfiguration complete message 1160. The receiver component 1250 may provide the capability message 1110 to the configuration component 122. The receiver component 1250 may provide the SCell switch request 1140 to the switch component 124. The receiver component 1250 may provide the RRC reconfiguration complete message 1160 to the reconfiguration component 126.

The capability component 1210 may be configured to receive an indication of a capability of the UE to switch from the primary cell to the one or more secondary cells configured for the UE in carrier aggregation as the new primary cell. For instance, the capability component 1210 may receive an RRC capability message including an information element for SCell switching (e.g., P-SCellSwitch). The capability component 1210 may determine that the UE is capable of SCell switching based on the receive capability message. The capability component 1210 may indicate to the configuration component 122 that the UE is capable of SCell switching.

The configuration component 122 may be configured to configure a UE with a primary cell and one or more secondary cells in carrier aggregation. For example, the configuration component 122 may generate an RRC configuration 1120 with multiple serving cells and carrier aggregation parameters for the UE. In some implementations, the configuration component 122 may configure the UE with SCell switching parameters such as P-SCell switch indication 1122, the switch threshold 1124, and the switch offset 1126. The configuration component 122 may transmit the configuration 1120 via the transmitter component 1252. The configuration component 122 may provide the SCell switching parameters to the switch component 124.

The switch component 124 may be configured to receive a request to configure a candidate beam of at least one candidate secondary cell of the one or more secondary cells as a new primary cell. For example, the switch component 124 may receive the SCell switch request 1140 via the receiver component 1250. For instance, the switch request 1140 may be the MAC-CE 1010 or another message such as an RRC message including the reference signal identifier of the candidate beam of a secondary cell. The received switch request 1140 indicates that a first radio condition of the UE for beams of a primary cell does not satisfy a first threshold (e.g., a BFR threshold) and that a second radio condition for the candidate beam of the at least one candidate secondary cell satisfies a second threshold (e.g., the switch threshold 1124).

The switch component 124 may determine whether to switch the candidate beam of the candidate secondary cell to be a primary cell. For example, the switch component 124 may determine whether the candidate secondary cell can act as a primary cell. The switch component 124 may determine whether the candidate secondary cell has available resources for the UE. If the switch component 124 determines to switch the candidate beam of the candidate secondary cell to be a primary cell, the switch component 124 may indicate the candidate beam and the candidate secondary cell to the reconfiguration component 126.

The reconfiguration component 126 may be configured to hand over the UE to a new primary cell. The reconfiguration component 126 may reconfigure the candidate secondary cell (e.g., SCell 1108) as the new primary cell. For example, the reconfiguration component 126 may transmit the RRC reconfiguration message 1150 to the UE 104 via the transmitter component 1252. The reconfiguration message 1150 may be a handover command that causes the UE to perform a handover procedure to the new primary cell. In some implementations, the reconfiguration message 1150 may reconfigure the PCell 1106 as a new secondary cell.

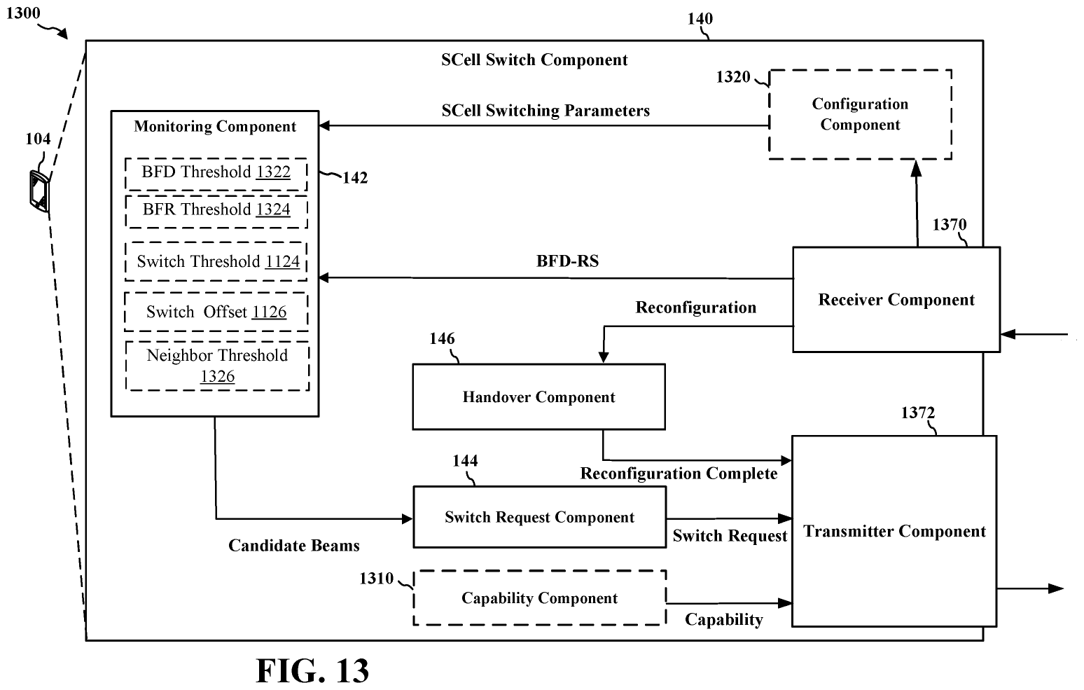

FIG. 13 is a conceptual data flow diagram 1300 illustrating the data flow between different means/components in an example UE 104, which may include the SCell switch component 140. The SCell switch component 140 may be implemented by the memory 360 and the Tx processor 368, the Rx processor 356, and/or the controller/processor 359. For example, the memory 360 may store executable instructions defining the SCell switch component 140 and the Tx processor 368, the Rx processor 356, and/or the controller/processor 359 may execute the instructions.

The UE 104 may include a receiver component 1370, which may include, for example, a RF receiver for receiving the signals described herein. The UE 104 may include a transmitter component 1372, which may include, for example, an RF transmitter for transmitting the signals described herein. In an aspect, the receiver component 1370 and the transmitter component 1372 may co-located in a transceiver such as the Tx/Rx 352 in FIG. 3.

As discussed with respect to FIG. 1, the SCell switch component 140 may include the monitoring component 142, the switch request component 144, and the handover component 146. In some implementations, the SCell switch component 140 may optionally include a capability component 1310 or a configuration component 1320.

The receiver component 1370 may receive DL signals described herein such as the configuration 1120, the BFD-RS 1132 and 1134, and the RRC reconfiguration message 1150. The receiver component 1370 may provide the configuration 1120 to the configuration component 1320. The receiver component 1370 may provide BFD-RS 1132 and 1134 (or measurements thereof) to the monitoring component 142. The receiver component 1370 may provide the RRC reconfiguration message 1150 to the handover component 146.

In some implementations, the capability component 1310 may be configured to transmit an indication of a capability of the UE to switch from the primary cell to the one or more secondary cells configured for the UE in carrier aggregation as the new primary cell. For example, the capability component 1310 may transmit an RRC capability message 1110 via the transmitter component 1372.

In some implementations, the configuration component 1320 may be configured to receive a configuration of SCell switching parameters. For example, the configuration component 1320 may receive a first threshold (e.g., a BFD threshold 1322), a second threshold (e.g., switch threshold 1124), a third threshold (e.g., switch offset 1126), and/or a fourth threshold (e.g., a neighbor threshold 1326). The configuration component 1320 may configure the monitoring component 142 with the SCell switching parameters.

The monitoring component 142 may be configured to monitor a first radio condition of the UE for beams of a primary cell and a second radio condition for beams of one or more secondary cells configured for the UE in carrier aggregation. For example, the monitoring component 142 may monitor an RSRP or SINR of the BFD-RS 1132 to determine the first radio condition for beams of the PCell 1106. The monitoring component 142 may monitor an RSRP or SINR of the BFD-RS 1134 to determine the second radio condition for beams of the SCell 1108. In some implementations, the monitoring component 142 may also monitor radio conditions of neighbor cells (e.g., neighbor cell 740). When the monitoring component 142 declares a beam failure for the primary cell, the monitoring component may concurrently monitor for candidate beams for the primary cell for a beam failure recovery procedure and for candidates beams on the secondary cell for a secondary cell switch procedure. The monitoring component 142 may compare the measured radio conditions to the respective configured thresholds to determine suitable candidate beams as discussed above regarding blocks 820, 830, and/or 910. The monitoring component 142 may provide the secondary cell candidate beams to the switch request component 144.

The switch request component 144 may be configured to transmit a request to configure a candidate beam of at least one candidate secondary cell of the one or more secondary cells as a new primary cell. For example, the switch request component 144 may transmit the request in response to the monitoring component 142 determining that the first radio condition does not satisfy the first threshold and that the second radio condition for the at least one candidate secondary cell satisfies the second threshold. For example, the switch request component 144 may transmit the SCell switch request 1140 via the transmitter component 1372. In some implementations, the switch request component 144 may be the MAC-CE 1010. The switch request component 144 may transmit the SCell switch request 1140 to either the PCell 1106 or the SCell 1108, for example, based on an available uplink grant. The switch request component 144 may use a scheduling request on the PUCCH to obtain an uplink grant. The MAC-CE 1010 may identify the cell index and candidate reference signal for at least one candidate beam. For instance, the MAC-CE 1010 may include information for a best candidate SCell beam. In some implementations, the MAC-CE 1010 may include information for all suitable candidate SCell beams. In some implementations, the switch request component 144 may be an RRC message including similar information as the MAC-CE 1010. The RRC message may be transmitted to the PCell 1106.

The handover component 146 may be configured to perform a handover to the new primary cell. For example, the handover component 146 may receive a handover command as an RRC reconfiguration message 1150 via the receiver component 1370. the handover component 146 may reconfigure the SCell 1108 as a new primary cell. The SCell 1108 may receive configuration parameters of the UE 104 from the PCell 1106 via a backhaul. Accordingly, once the UE 104 reconfigures the SCell 1108, the UE 104 may use an RRC connection with the new PCell to complete the handover. The UE 104 may transmit an RRC reconfiguration complete message 1160 to the new primary cell.

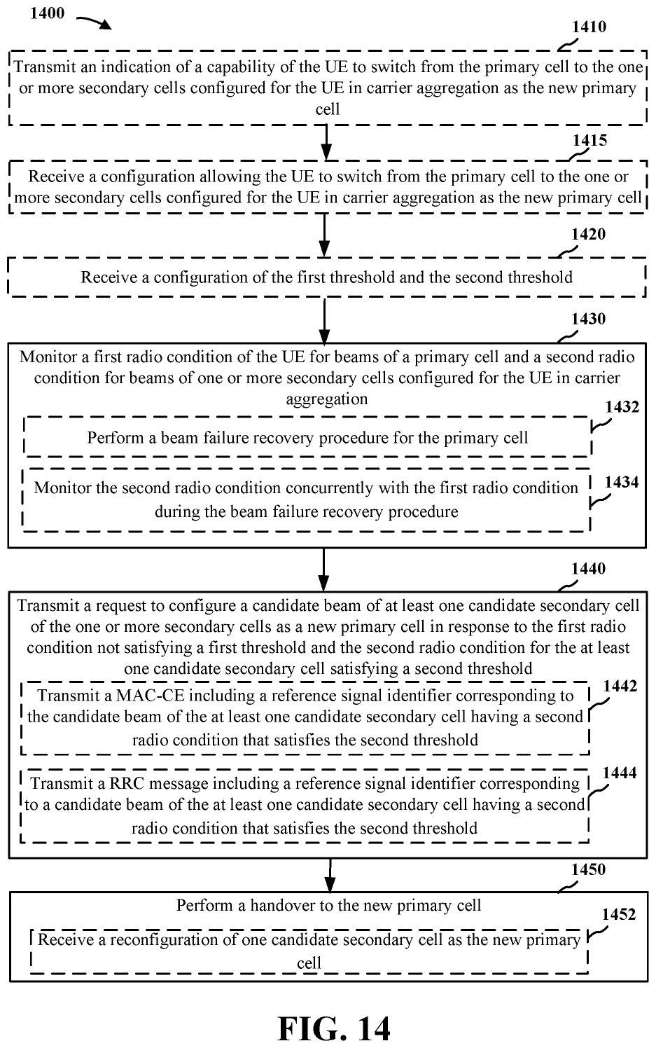

FIG. 14 is a flowchart of an example method 1400 for a UE 104 to perform a switch to a SCell using beam failure procedures. The method 1400 may be performed by a UE 104 (such as the UE 104, which may include the memory 360 and which may be the entire UE 104 or a component of the UE 104 such as the SCell switch component 140, Tx processor 368, the Rx processor 356, or the controller/processor 359). The method 1400 may be performed by the SCell switch component 140 in communication with the prediction control component 120 of the base station 102. Optional blocks are shown with dashed lines.

At block 1410, the method 1400 may optionally include transmitting an indication of a capability of the UE to switch from the primary cell to the one or more secondary cells configured for the UE in carrier aggregation as the new primary cell. In some implementations, for example, the UE 104, the Tx processor 368 or the controller/processor 359 may execute the SCell switch component 140 or the capability component 1310 to transmit the indication of a capability (e.g., capability message 1110) of the UE 104 to switch from the primary cell to the one or more secondary cells configured for the UE in carrier aggregation as the new primary cell. Accordingly, the UE 104, the Tx processor 368, or the controller/processor 359 executing the SCell switch component 140 or the capability component 1310 may provide means for transmitting a request for activation or deactivation of beam failure prediction.

At block 1415, the method 1400 may optionally include receiving a configuration allowing the UE to switch from the primary cell to the one or more secondary cells configured for the UE in carrier aggregation as the new primary cell. In some implementations, for example, the UE 104, the Rx processor 356 or the controller/processor 359 may execute the SCell switch component 140 or the configuration component 1320 to receive a configuration e.g., P-SCell Switch indication 1122) allowing the UE 104 to switch from the primary cell to the one or more secondary cells configured for the UE in carrier aggregation as the new primary cell. Accordingly, the UE 104, the Rx processor 356, or the controller/processor 359 executing the SCell switch component 140 or the configuration component 1320 may provide means for receiving a configuration allowing the UE to switch from the primary cell to the one or more secondary cells configured for the UE in carrier aggregation as the new primary cell.

At block 1420, the method 1400 may optionally include receiving a configuration of a first threshold and a second threshold. In some implementations, for example, the UE 104, the Rx processor 356 or the controller/processor 359 may execute the SCell switch component 140 or the configuration component 1320 to receive a configuration 1120 of a first threshold (e.g., BFR threshold 1324) and a second threshold (e.g., switch threshold 1124). In some implementations, the configuration component 1320 may receive a configuration of additional thresholds such as the BFD threshold 1322 for declaring a beam failure, a third threshold (e.g., switch offset 1126) for comparing a first radio condition and a second radio condition, or a fourth threshold (e.g., neighbor threshold 1326) for evaluating neighbor cells 740. Accordingly, the UE 104, the Rx processor 356, or the controller/processor 359 executing the SCell switch component 140 or the configuration component 1320 may provide means for receiving a configuration of a first threshold and a second threshold.

At block 1430, the method 1400 includes monitoring a first radio condition of the UE for beams of a primary cell and a second radio condition for beams of one or more secondary cells configured for the UE in carrier aggregation. In some implementations, for example, the UE 104, the Rx processor 356. or the controller/processor 359 may execute the SCell switch component 140 or the monitoring component 142 to monitor a first radio condition of the UE for beams of a PCell 1106 and a second radio condition for beams of one or more SCell 1108 configured for the UE 104 in carrier aggregation. In some implementations, at sub-block 1432, the block 1430 may optionally include performing a beam failure recovery procedure for the primary cell. For example, the monitoring component 142 may detect a beam failure based on a BFD threshold as described with respect to FIG. 5. The monitoring component 142 may search for suitable PCell candidate beams for the BFR procedure in response to declaring a beam failure. At sub-block 1434, the block 1430 may optionally include monitoring the second radio condition concurrently with the first radio condition during the beam failure recovery procedure. For instance, the monitoring component 142 may monitor the BFD-RS 1134 for secondary cells during a BFR timer. Accordingly, the UE 104, the Rx processor 356, or the controller/processor 359 executing the SCell switch component 140 or the monitoring component 142 may provide means for monitoring a first radio condition of the UE for beams of a primary cell and a second radio condition for beams of one or more secondary cells configured for the UE in carrier aggregation.

At block 1440, the method 1400 includes transmitting a request to configure a candidate beam of at least one candidate secondary cell of the one or more secondary cells as a new primary cell in response to the first radio condition not satisfying a first threshold and the second radio condition for the at least one candidate secondary cell satisfying a second threshold. In some implementations, for example, the UE 104, the Tx processor 368 or the controller/processor 359 may execute the SCell switch component 140 or the switch request component 144 to transmit a request (e.g., SCell switch request 1140) to configure a candidate beam (e.g., beam 732) of at least one candidate secondary cell 730 of the one or more secondary cells as a new primary cell in response to the first radio condition not satisfying a first threshold (e.g., BFR threshold 1324) and the second radio condition for the at least one candidate secondary cell satisfying a second threshold (e.g., switch threshold 1124). In some implementations, transmitting the request is further in response to the second radio condition of the candidate beam of the at least one candidate secondary cell being greater than the first radio condition of a best beam of the primary cell by at least a third threshold (e.g., switch offset 1126). In some implementations, transmitting the request is further in response to values for configured measurement objects corresponding to neighbor cells not satisfying a fourth threshold (e.g., neighbor threshold 1326) for a handover to a neighbor cell.

In some implementations, at sub-block 1442, the block 1440 may include transmitting a MAC-CE 1010 including a reference signal identifier 1026 corresponding to the candidate beam 732 of the at least one candidate secondary cell 730 having a second radio condition that satisfies the second threshold. For instance, the switch request component 144 may transmit the MAC-CE 1010 on an uplink grant for the primary cell or for one of the one or more secondary cells. In some implementations, at sub-block 1444, the block 1440 may optionally include transmitting a RRC message including a reference signal identifier corresponding to a candidate beam of the at least one candidate secondary cell having a second radio condition that satisfies the second threshold. Accordingly, the UE 104, the Tx processor 368, or the controller/processor 359 executing the SCell switch component 140 or the capability component 1310 may provide means for transmitting a request to configure a candidate beam of at least one candidate secondary cell of the one or more secondary cells as a new primary cell in response to the first radio condition not satisfying a first threshold and the second radio condition for the at least one candidate secondary cell satisfying a second threshold.

At block 1450, the method 1400 includes performing a handover to the new primary cell. In some implementations, for example, the UE 104, the Rx processor 356. or the controller/processor 359 may execute the SCell switch component 140 or the handover component 146 to perform a handover to the new primary cell. In some implementations, at sub-block 1452, the block 1450 may optionally include receiving a reconfiguration (e.g., RRC reconfiguration message 1150) of one candidate secondary cell as the new primary cell. The block 1450 may also optionally include transmitting an RRC reconfiguration complete message 1160. Accordingly, the UE 104, the Rx processor 356, or the controller/processor 359 executing the SCell switch component 140 or the handover component 146 may provide means for performing a handover to the new primary cell.

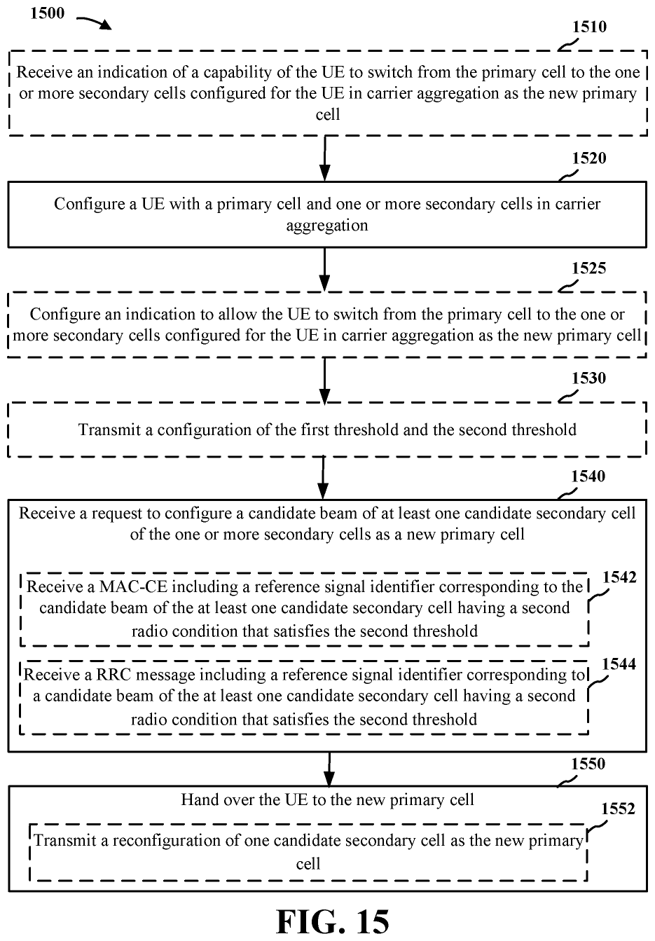

FIG. 15 is a flowchart of an example method 1500 for a base station to switch a UE to a secondary cell. The method 1500 may be performed by a base station (such as the base station 102, which may include the memory 376 and which may be the entire base station 102 or a component of the base station 102 such as the SCell control component 120, the Tx processor 316, the Rx processor 370, or the controller/processor 375). The method 1500 may be performed by the SCell control component 120 in communication with the SCell switch component 140 of the UE 104.

At block 1510, the method 1500 may optionally include receiving an indication of a capability of the UE to switch from the primary cell to the one or more secondary cells configured for the UE in carrier aggregation as the new primary cell. In some implementations, for example, the base station 102, the Rx processor 370, or the controller/processor 375 may execute the SCell control component 120 or the capability component 1210 receive an indication of a capability of the UE to switch from the primary cell to the one or more secondary cells configured for the UE in carrier aggregation as the new primary cell. Accordingly, the base station 102, the Rx processor 370, or the controller/processor 375 executing the SCell control component 120 or the capability component 1210 may provide means for receiving an indication of a capability of the UE to switch from the primary cell to the one or more secondary cells configured for the UE in carrier aggregation as the new primary cell.

At block 1520, the method 1500 includes configuring a UE with a primary cell and one or more secondary cells in carrier aggregation. In some implementations, for example, the base station 102, the Tx processor 316, or the controller/processor 375 may execute the SCell control component 120 or the configuration component 122 to configure a UE 104 with a primary cell 710 and one or more secondary cells 720, 730 in carrier aggregation. Accordingly, the base station 102, the Tx processor 316, or the controller/processor 375 executing the SCell control component 120 or the configuration component 122 may provide means for configuring a UE with a primary cell and one or more secondary cells in carrier aggregation.

At block 1525, the method 1500 may optionally include configuring an indication to allow the UE to switch from the primary cell to the one or more secondary cells configured for the UE in carrier aggregation as the new primary cell. In some implementations, for example, the base station 102, the Tx processor 316, or the controller/processor 375 may execute the SCell control component 120 or the configuration component 122 to configure an indication 1122 to allow the UE to switch from the primary cell to the one or more secondary cells configured for the UE in carrier aggregation as the new primary cell. Accordingly, the base station 102, the Tx processor 316, or the controller/processor 375 executing the SCell control component 120 or the configuration component 122 may provide means for configuring an indication to allow the UE to switch from the primary cell to the one or more secondary cells configured for the UE in carrier aggregation as the new primary cell.

At block 1530, the method 1500 may optionally include transmitting a configuration of a first threshold and a second threshold. In some implementations, for example, the base station 102, the Tx processor 316, or the controller/processor 375 may execute the SCell control component 120 or the configuration component 122 to transmit a configuration of a first threshold (e.g., BFR threshold 1324) and a second threshold (e.g., switch threshold 1124). The block 1530 may further include transmitting a configuration of a third threshold (e.g., switch offset 1126) and/or a fourth threshold (e.g., neighbor threshold 1326). Accordingly, the base station 102, the Tx processor 316, or the controller/processor 375 executing the SCell control component 120 or the configuration component 122 may provide means for transmitting a configuration of a first threshold and a second threshold.

At block 1540, the method 1500 includes receiving a request to configure a candidate beam of at least one candidate secondary cell of the one or more secondary cells as a new primary cell. In some implementations, for example, the base station 102, the Rx processor 370, or the controller/processor 375 may execute the SCell control component 120 or the switch component 124 to receive the request to configure the candidate beam of at least one candidate secondary cell of the one or more secondary cells as the new primary cell. In some implementations, receiving the request indicates that the second radio condition of the candidate beam of the at least one candidate secondary cell is greater than the first radio condition of a best beam of the primary cell by at least a third threshold (e.g., switch offset 1126). In some implementations, receiving the request indicates that values for configured measurement objects for the UE corresponding to neighbor cells 740 do not satisfy a fourth threshold (e.g., neighbor threshold 1326) for a handover to a neighbor cell. In some implementations, at sub-block 1542, the block 1540 may optionally include receiving a MAC-CE including a reference signal identifier corresponding to the candidate beam of the at least one candidate secondary cell having a second radio condition that satisfies the second threshold. For instance, the switch component 124 may receive the MAC-CE 1010 on an uplink grant for the primary cell or one of the one or more secondary cells. In some implementations, the MAC-CE includes a bit 1024 indicating the request to switch to the candidate beam of the at least one candidate secondary cell instead of failure of the candidate beam. In some implementations, at sub-block 1544, the block 1540 may optionally include receiving a RRC message including a reference signal identifier corresponding to a candidate beam of the at least one candidate secondary cell having a second radio condition that satisfies the second threshold. Accordingly, the base station 102, the Rx processor 370, or the controller/processor 375 executing the SCell control component 120 or the switch component 124 may provide means for receiving a request to configure a candidate beam of at least one candidate secondary cell of the one or more secondary cells as a new primary cell.

At block 1550, the method 1500 may optionally include handing over the UE to the new primary cell. In some implementations, for example, the base station 102, the Tx processor 316, or the controller/processor 375 may execute the SCell control component 120 or the reconfiguration component 126 to hand over the UE 104 to the new primary cell (e.g., cell 730). In some implementations, at block 1552, the block 1550 may optionally include transmitting a reconfiguration (e.g., RRC reconfiguration message 1150) of one candidate secondary cell as the new primary cell. Accordingly, the base station 102, the Tx processor 316, or the controller/processor 375 executing the SCell control component 120 or the reconfiguration component 126 may provide means for handing over the UE to the new primary cell.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

The following numbered clauses provide an overview of aspects of the present disclosure:
Clause 1. A method of wireless communications at a user equipment (UE), comprising: monitoring a first radio condition of the UE for beams of a primary cell and a second radio condition for beams of one or more secondary cells configured for the UE in carrier aggregation; transmitting a request to configure a candidate beam of at least one candidate secondary cell of the one or more secondary cells as a new primary cell in response to the first radio condition not satisfying a first threshold and the second radio condition for the at least one candidate secondary cell satisfying a second threshold; and performing a handover to the new primary cell.
Clause 2. The method of clause 1, wherein the monitoring comprises performing a beam failure recovery procedure for the primary cell, wherein the UE is configured to monitor the second radio condition concurrently with the first radio condition during the beam failure recovery procedure.
Clause 3. The method of clause 1 or 2, wherein transmitting the request comprises transmitting a media access control (MAC) control element (CE) including a reference signal identifier corresponding to the candidate beam of the at least one candidate secondary cell having a second radio condition that satisfies the second threshold.
Clause 4. The method of clause 3, wherein transmitting the request comprises transmitting the MAC-CE on an uplink grant for the primary cell or for one of the one or more secondary cells.
Clause 5. The method of any of clauses 1-4, further comprising transmitting an indication of a capability of the UE to switch from the primary cell to the one or more secondary cells configured for the UE in carrier aggregation as the new primary cell.
Clause 6. The method of any of clauses 1-5, further comprising receiving a configuration of the first threshold and the second threshold.
Clause 7. The method of any of clauses 1-6, wherein transmitting the request is further in response to the second radio condition of the candidate beam of the at least one candidate secondary cell being greater than the first radio condition of a best beam of the primary cell by at least a third threshold.
Clause 8. The method of any of clauses 1-7, wherein transmitting the request is further in response to values for configured measurement objects corresponding to neighbor cells not satisfying a fourth threshold for a handover to a neighbor cell.
Clause 9. The method of any of clauses 1-8, wherein performing the handover to the new primary cell comprises receiving a reconfiguration of one candidate secondary cell as the new primary cell.
Clause 10. The method of any of clauses 1 or 5-9, wherein transmitting the request comprises transmitting a radio resource control (RRC) message including a reference signal identifier corresponding to a candidate beam of the at least one candidate secondary cell having a second radio condition that satisfies the second threshold.
Clause 11. An apparatus for wireless communication for a user equipment (UE), comprising: a memory storing computer-executable instructions; and at least one processor coupled to the memory and configured to execute the computer-executable instructions to cause the UE to perform the method of any of clauses 1-10.
Clause 12. An apparatus for wireless communication for a user equipment (UE), comprising means for performing the method of any of clauses 1-10.
Clause 13. A non-transitory computer-readable medium storing computer-executable instructions configured to cause a UE to perform the method of any of clauses 1-10.
Clause 14. A method of wireless communications at a network entity, comprising: configuring a user equipment (UE) with a primary cell and one or more secondary cells in carrier aggregation; receiving a request to configure a candidate beam of at least one candidate secondary cell of the one or more secondary cells as a new primary cell, wherein the request indicates that a first radio condition of the UE for beams of a primary cell does not satisfy a first threshold and that a second radio condition for the candidate beam of the at least one candidate secondary cell satisfies a second threshold; and handing over the UE to the new primary cell.
Clause 15. The method of clause 14, wherein receiving the request comprises receiving a media access control (MAC) control element (CE) including a reference signal identifier corresponding to the candidate beam of the at least one candidate secondary cell having the second radio condition that satisfies the second threshold.
Clause 16. The method of clause 15, wherein receiving the request comprises receiving the MAC-CE on an uplink grant for the primary cell or one of the one or more secondary cells.
Clause 17. The method of clause 15, wherein the MAC-CE includes a bit indicating the request to switch to the candidate beam of the at least one candidate secondary cell instead of failure of the candidate beam.
Clause 18. The method of any of clauses 14-17, further comprising receiving an indication of a capability of the UE to switch from the primary cell to the one or more secondary cells configured for the UE in carrier aggregation as the new primary cell.
Clause 19. The method of any of clauses 14-18, further comprising configuring an indication to allow the UE to switch from the primary cell to the one or more secondary cells configured for the UE in carrier aggregation as the new primary cell.
Clause 20. The method of any of clauses 14-19, wherein receiving the request indicates that the second radio condition of the candidate beam of the at least one candidate secondary cell is greater than the first radio condition of a best beam of the primary cell by at least a third threshold.
Clause 21. The method of any of clauses 14-20, wherein receiving the request indicates that values for configured measurement objects for the UE corresponding to neighbor cells do not satisfy a fourth threshold for a handover to a neighbor cell.
Clause 22. The method of any of clauses 14-21, wherein handing over the UE to the new primary cell comprises transmitting a reconfiguration of one candidate secondary cell as the new primary cell.
Clause 23. The method of any of clauses 14 or 18-22, wherein receiving the request comprises receiving a radio resource control (RRC) message including a reference signal identifier corresponding to a candidate beam of the at least one candidate secondary cell having a second radio condition that satisfies the second threshold.
Clause 24. An apparatus for wireless communication for a base station, comprising: a memory storing computer-executable instructions; and at least one processor coupled to the memory and configured to execute the computer-executable instructions to cause the base station to perform he method of any of clauses 14-23.
Clause 25. An apparatus for wireless communication for a base station, comprising means for performing the method of any of clauses 14-23.
Clause 26. A non-transitory computer-readable medium storing computer-executable instructions configured to cause a base station to perform the method of any of clauses 14-23.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communications at a user equipment (UE), comprising:
monitoring a first radio condition of the UE for beams of a primary cell and a second radio condition for beams of one or more secondary cells configured for the UE in carrier aggregation;
transmitting a request to configure a candidate beam of at least one candidate secondary cell of the one or more secondary cells as a new primary cell in response to the first radio condition not satisfying a first threshold and the second radio condition for the at least one candidate secondary cell satisfying a second threshold; and
performing a handover to the new primary cell.

2. The method of claim 1, wherein the monitoring comprises performing a beam failure recovery procedure for the primary cell, wherein the UE is configured to monitor the second radio condition concurrently with the first radio condition during the beam failure recovery procedure.

3. The method of claim 1, wherein transmitting the request comprises transmitting a media access control (MAC) control element (CE) including a reference signal identifier corresponding to the candidate beam of the at least one candidate secondary cell having a second radio condition that satisfies the second threshold.

4. The method of claim 3, wherein transmitting the request comprises transmitting the MAC-CE on an uplink grant for the primary cell or for one of the one or more secondary cells.

5. The method of claim 1, further comprising transmitting an indication of a capability of the UE to switch from the primary cell to the one or more secondary cells configured for the UE in carrier aggregation as the new primary cell.

6. The method of claim 1, further comprising receiving a configuration of the first threshold and the second threshold.

7. The method of claim 1, wherein transmitting the request is further in response to the second radio condition of the candidate beam of the at least one candidate secondary cell being greater than the first radio condition of a best beam of the primary cell by at least a third threshold.

8. The method of claim 1, wherein transmitting the request is further in response to values for configured measurement objects corresponding to neighbor cells not satisfying a fourth threshold for a handover to a neighbor cell.

9. The method of claim 1, wherein performing the handover to the new primary cell comprises receiving a reconfiguration of one candidate secondary cell as the new primary cell.

10. The method of claim 1, wherein transmitting the request comprises transmitting a radio resource control (RRC) message including a reference signal identifier corresponding to a candidate beam of the at least one candidate secondary cell having a second radio condition that satisfies the second threshold.

11. A method of wireless communications at a network entity, comprising:
configuring a user equipment (UE) with a primary cell and one or more secondary cells in carrier aggregation;
receiving a request to configure a candidate beam of at least one candidate secondary cell of the one or more secondary cells as a new primary cell, wherein the request indicates that a first radio condition of the UE for beams of a primary cell does not satisfy a first threshold and that a second radio condition for the candidate beam of the at least one candidate secondary cell satisfies a second threshold; and
handing over the UE to the new primary cell.

12. The method of claim 11, wherein receiving the request comprises receiving a media access control (MAC) control element (CE) including a reference signal identifier corresponding to the candidate beam of the at least one candidate secondary cell having the second radio condition that satisfies the second threshold.

13. The method of claim 12, wherein receiving the request comprises receiving the MAC-CE on an uplink grant for the primary cell or one of the one or more secondary cells.

14. The method of claim 12, wherein the MAC-CE includes a bit indicating the request to switch to the candidate beam of the at least one candidate secondary cell instead of failure of the candidate beam.

15. The method of claim 11, further comprising receiving an indication of a capability of the UE to switch from the primary cell to the one or more secondary cells configured for the UE in carrier aggregation as the new primary cell.

16. The method of claim 11, further comprising configuring an indication to allow the UE to switch from the primary cell to the one or more secondary cells configured for the UE in carrier aggregation as the new primary cell.

17. The method of claim 11, wherein receiving the request indicates that the second radio condition of the candidate beam of the at least one candidate secondary cell is greater than the first radio condition of a best beam of the primary cell by at least a third threshold.

18. The method of claim 11, wherein receiving the request indicates that values for configured measurement objects for the UE corresponding to neighbor cells do not satisfy a fourth threshold for a handover to a neighbor cell.

19. The method of claim 11, wherein handing over the UE to the new primary cell comprises transmitting a reconfiguration of one candidate secondary cell as the new primary cell.

20. The method of claim 11, wherein receiving the request comprises receiving a radio resource control (RRC) message including a reference signal identifier corresponding to a candidate beam of the at least one candidate secondary cell having a second radio condition that satisfies the second threshold.

21. An apparatus for wireless communication for a user equipment (UE), comprising:
a memory storing computer-executable instructions; and
at least one processor coupled to the memory and configured to execute the computer-executable instructions to cause the UE to:
monitoring a first radio condition of the UE for beams of a primary cell and a second radio condition for beams of one or more secondary cells configured for the UE in carrier aggregation;
transmitting a request to configure a candidate beam of at least one candidate secondary cell of the one or more secondary cells as a new primary cell in response to the first radio condition not satisfying a first threshold and the second radio condition for the at least one candidate secondary cell satisfying a second threshold; and
performing a handover to the new primary cell.

22. The apparatus of claim 21, wherein to monitor the first radio condition and the second radio condition, the at least one processor is configured to perform a beam failure recovery procedure for the primary cell, wherein the UE is configured to monitor the second radio condition concurrently with the first radio condition during the beam failure recovery procedure.

23. The apparatus of claim 21, wherein to transmit the request, the at least one processor is configured to cause the UE to transmit a media access control (MAC) control element (CE) including a reference signal identifier corresponding to the candidate beam of the at least one candidate secondary cell having a second radio condition that satisfies the second threshold.

24. The apparatus of claim 23, wherein to transmit the request, the at least one processor is configured to cause the UE to transmit the MAC-CE on an uplink grant for the primary cell or for one of the one or more secondary cells.

25. The apparatus of claim 21, wherein the at least one processor is configured to cause the UE to transmit an indication of a capability of the UE to switch from the primary cell to the one or more secondary cells configured for the UE in carrier aggregation as the new primary cell.

26. The apparatus of claim 21, wherein the at least one processor is configured to cause the UE to receive a configuration of the first threshold and the second threshold.

27. The apparatus of claim 21, wherein transmitting the request is further in response to the second radio condition of the candidate beam of the at least one candidate secondary cell being greater than the first radio condition of a best beam of the primary cell by at least a third threshold.

28. The apparatus of claim 21, wherein transmitting the request is further in response to values for configured measurement objects corresponding to neighbor cells not satisfying a fourth threshold for a handover to a neighbor cell.

29. The apparatus of claim 21, wherein to perform the handover to the new primary cell, the at least one processor is configured to cause the UE to receive a reconfiguration of one candidate secondary cell as the new primary cell.

30. An apparatus for wireless communication for a base station, comprising:
a memory storing computer-executable instructions; and
at least one processor coupled to the memory and configured to execute the computer-executable instructions to cause the base station to:
configure a user equipment (UE) with a primary cell and one or more secondary cells in carrier aggregation;
receive a request to configure a candidate beam of at least one candidate secondary cell of the one or more secondary cells as a new primary cell, wherein the request indicates that a first radio condition of the UE for beams of a primary cell does not satisfy a first threshold and that a second radio condition for the candidate beam of the at least one candidate secondary cell satisfies a second threshold; and
hand over the UE to the new primary cell.
